(19) United States
(12) Patent Application Publication
(10) Pub. No.: US 2026/0317560 A1
(43) Pub. Date: Oct. 15, 2026

(54) METHOD OF COATING A PROFESSIONAL MUSICAL INSTRUMENT IN DURABLE GOLD LEAF OF HIGH PURITY WHILE ADHERING ART AND FRET MARKERS

(71) Applicants: Andrew G. Watters, Redwood City, CA (US); Claire Roman, Santa Clara, CA (US)

(72) Inventors: Andrew G. Watters, Redwood City, CA (US); Claire Roman, Santa Clara, CA (US)

(21) Appl. No.: 19/328,228

(22) Filed: Sep. 15, 2025

(51) Int. Cl. C09D 7/61; C08K 3/08; C09D 175/04

(52) U.S. Cl. CPC C09D 7/61; C09D 175/04; C08K 2003/0831

(57) ABSTRACT

A method for creating and applying a durable yet highly pure gold leaf coating on a musical instrument, optionally with strongly adhered artwork and on-surface fret markers, is provided. The disclosed method and formula also allow for convenient application of the coating on a professional musical instrument with ordinary tools in a typical workshop environment, as opposed to application in a serious industrial manufacturing facility or requiring specialty tools.

### FIELD

The present application relates to a method for creating and applying a composite coating for a musical instrument in highly pure (i.e., 24 karat) gold that is normally unsuitable for musical instruments because it is extremely fragile, and not at all durable. Additionally, the application discloses a method for adhering permanent artwork and/or fret markers to the aforementioned highly pure yet durable gold coating.

### BACKGROUND

Gold is normally very unsuitable as a musical instrument coating because it is fragile and highly malleable, and (especially when made into gold leaf) is also translucent, extremely thin, and difficult to apply to any surface. Gold is also unreasonably expensive to use as a coating for an instrument because of the sophisticated facilities, machines, and tools required to electroplate an instrument-which are also impractical for a wood instrument because of the nature of electroplating that requires the use of fluids that soak into porous materials. In addition, because gold is so chemically neutral, few materials adhere to it properly, and it does not adhere properly to most base materials. Thus, an actual gold coating is extremely rare on a musical instrument. These challenges are only magnified when highly pure 24 karat gold is used for coating an instrument, as opposed to less pure 22 karat gold leaf, or imitation gold leaf. 24 karat gold is highly desirable because the deep gold color is superior to less pure varietals of gold leaf. Further, traditional gilding, such as water gilding, is also highly unsuitable for coating a musical instrument because the water soaks into the tonewood and causes other problems, while also having poor durability. Even if a common process for gilding a musical instrument with a durable gold coating were available, the issue of placing artwork or gilding an instrument neck and placing fret markers on the gilded neck would be difficult to impossible to resolve, because the art and fret markers would not reliably adhere to the gold. Further, efforts to increase the durability of gold normally reduce its aesthetic appeal as a coating, which is why most gilding techniques leave gold exposed and uncoated, which also leaves the above challenges unresolved.

### SUMMARY

The present invention solves the above-indicated problems by providing a method of creating and applying a gold coating to an instrument in such a way that the gold coating is durable and simultaneously allows the permanent, proper adhesion of artwork and fret markers applied during the process. Of key note, the invention allows the application of a durable gold coating and fret markers/artwork in an ordinary workshop environment, as opposed to a high-level industrial manufacturing or electroplating facility. As such, a durable gold coating is now within reach of the sophisticated hobbyist, and the end user has a handmade musical instrument that is durable enough for professional touring use without undue risk of damage to the coating, art, and fret markers. Further, the user can expect a long/indefinite life for the fret markers, requiring only the re-application of the final layers of polyurethane in the event an unreasonable wear pattern or other consumption of the final layers of the coating occur. In addition, the method permits easy spot repairs of damage that does occur. Finally, the cost of the process is far lower than working with an industrial manufacturer, and can be accomplished at a fraction of the price of electroplating in a casual setting, which presents many advantages in the way of cost, efficiency, and time.

### BRIEF DESCRIPTION OF THE DRAWINGS

FIG. 1 is a layer diagram showing the order in which the coating layers are applied, and the contents of each layer, as applied to an instrument called Blackstar, which is one embodiment of the present invention that is in actual use.

### DETAILED DESCRIPTION

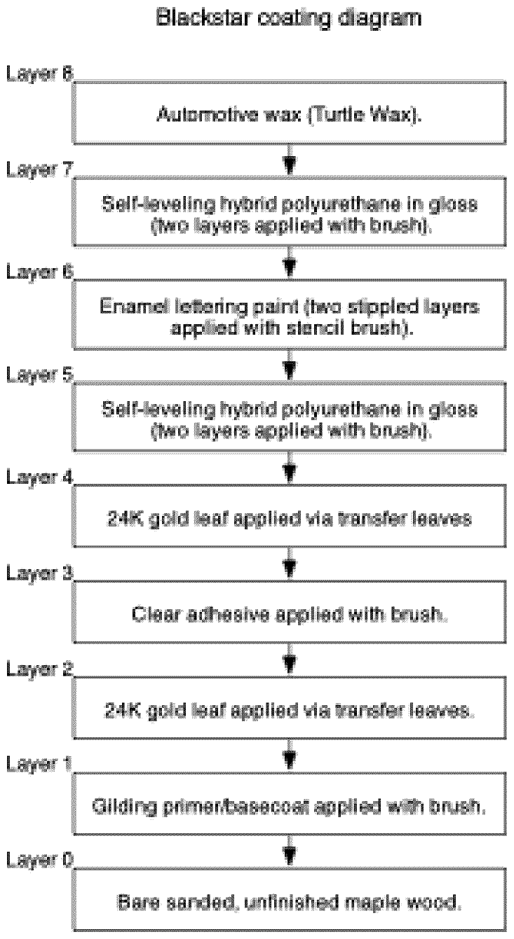

The first embodiment of the disclosed method is illustrated in FIG. 1, which shows the winning formula discovered through trial and error, and the method of application as applied to a bass guitar called Blackstar. First, a primer/basecoat suitable for gilding (known in the art as burnishing sealer), with a typical chemical composition of between 0 and 1% Diacetone Alcohol, 22 and 39% Mineral Spirits, 0 and 1% Modified Polyamide, and 11 to 26% Varnish Makers and Painters Naphtha, is applied to the bare sanded wood in one or two coats. Once the burnishing sealer is dry, gilding adhesive (“size”), with a typical chemical composition of either (1) between 0 and 2% Aqua Ammonia, 1 to 8% Ethanol, and 51 to 82% water (water-based size), or (2) 46 to 77% Mineral Spirits (quick dry size) is applied to the surface of the sealer. Then, the initial layer of gold leaf consisting of 24 karat or other highly pure gold is promptly applied to the adhesive, followed by additional of the same gilding adhesive, and then another layer of highly pure gold leaf (at least two layers of gold). After the gold is applied, the instrument is coated in self-leveling oil-modified polyurethane (two coats) whose composition is described in U.S. Pat. No. 5,439,952A, or its substantial equivalent, which is applied with a brush, and allowed to cure according to the manufacturer's specifications. At this point, standard professional lettering enamel may be applied with a stencil or other device by way of a stippling technique (i.e., a vertical tapping motion with a stencil brush) directly onto the polyurethane (two layers of enamel), in order to place art and fret markers directly on the polyurethane surface while maintaining the illusion that the lettering paint is sitting directly on the gold due to the thinness of the lettering paint layers. Optionally, for extra adhesion, the user may lightly sand the polyurethane layer before applying the lettering paint, although this is not required. The lettering paint is allowed to cure according to its manufacturer's specifications. The instrument is then coated with at least two more layers of the same polyurethane applied with a brush, and allowed to fully cure. The final touch is an optional layer of standard automotive wax, which produces a slick, smooth final finish that players appreciate. The coating is thin, yet reasonably durable, and results in a handmade/relic look while providing a deep shimmering effect, with the gold appearing to be suspended in a clear layer of liquid, with art and fret markers that “float” very slightly above the gold but within the finish. Essentially, the curing of the polyurethane layers on the gold creates a shell on which other materials can be applied, and the binding of the enamel lettering paint to the polyurethane followed by additional layers of polyurethane create a transparent composite that protects the optional art and fret markers for long-term use. The result is extraordinary compared to all but the world's finest musical instruments, yet it can be achieved in an ordinary workshop with regular tools instead of an industrial manufacturing facility with specialized machines. The finish is impervious to the “fingernail test” of durability, and moderately resistant to dings and scratches, which is acceptable for an instrument that will be taken on tour and professionally used. The challenges solved in this method are (1) how to attain a reasonably durable finish on a gilded professional instrument, and (2) how to adhere painted-on fret markers to a gilded surface while retaining the feel and durability required of a professional touring instrument. The discovery of this method and process for creating and applying the coating enables the hobbyist to execute a world-class gold finish in a casual environment, which is novel.

1. A musical instrument coating composed of burnishing sealer, gold leaf of high purity, gilding adhesive, polyurethane, and optional enamel paint that, when combined and applied according to the specified process in the indicated quantities and order of application, realizes a durable gold finish on a musical instrument with permanently adhered art and/or fret markers, which in one embodiment appear to be suspended in a clear layer over a reflective, shimmering base of visually appealing textured gold.

2. The process and method for creating the coating described in claim 1.

3. The process and method for applying the coating described in claim 1 to a musical instrument.
